(19) United States
(12) Patent Application Publication
(10) Pub. No.: US 2026/0309481 A1
(43) Pub. Date: Oct. 8, 2026

(54) DEVICE FOR MEASURING THE FLATNESS OF A SURFACE OR THE THICKNESS OF A FLAT GLASS PANEL

(71) Applicant: Hermann SONNLEITNER, Sankt Peter in der Au (AT)

(72) Inventor: Hermann SONNLEITNER, Sankt Peter in der Au (AT)

(21) Appl. No.: 19/480,645

(22) PCT Filed: Apr. 23, 2024
(86) PCT No.: PCT/AT2024/000007

§ 371 Date: Oct. 31, 2025

(30) Foreign Application Priority Data
May 3, 2023 (AT) A 60/2023

(51) Int. Cl. G01B 11/06; G01B 11/30; G01M 11/00

(52) U.S. Cl. CPC G01B 11/0608; G01B 11/303; G01B 11/306; G01M 11/005

(57) ABSTRACT

A device for measuring the flatness of a surface or the thickness of a flat glass panel includes at least three light sources which emit light divergently and a camera for capturing the light reflected from the surface in a directed manner and originally coming from the light sources emitting divergently. The device also includes at least three light sources which each emit light in a collimated manner along a definedly positioned straight line, wherein the camera is also provided for capturing the light reflected from the surface in a scattered manner and originally coming from the light sources emitting in a collimated manner.

The invention relates to a device for measuring the flatness of a surface or the thickness of a flat glass panel.

Documents EP 0433555A2, DE 102018202625A1 , and WO 2022214159 A1 show by way of example a known principle for optically measuring the geometry of a surface on the basis of diffusely backscattered light. A collimated light beam having the smallest possible cross-sectional area, which typically originates from a laser, is conducted along a predetermined straight line defined in space on the surface. The surface is imaged by a camera—thus a combination of an objective and a location-resolving optical sensor. The location of the incidence of the collimated light beam on the surface appears as a bright spot in the camera image. From the position of this spot in the image, the position of the spot depicted thereby in space is back calculated.

According to DE 2853816A1 , a collimated light beam having known position and alignment in space is emitted onto a reflective surface to be measured and the light beam reflected in a directed (thus not diffuse) manner from the surface is incident on a point of a light-sensitive detector surface arranged in a known position. From the position of the point of incidence on the detector surface, possible value pairs of position and angle alignment can be back calculated with respect to the point on the surface to be measured from which the beam was reflected. By applying the knowledge about further boundary conditions—which is obtained, for example, by further measurements in positions changed in a defined manner—the position and/or the angle alignment can be unambiguously back calculated. For a simple good/bad assessment of the flatness or more generally the dimensional accuracy of the surface to be measured, the dimension of the distance between the actual point of incidence and the point of incidence of the reflected beam on the detector surface present in the ideal case can also simply be used.

According to US 5471307 A, in parallel to a surface to be measured which reflects in a directed manner, an illuminated flat pattern surface provided with a regular light-dark pattern is arranged, and the image of the pattern surface reflected on the surface to be measured is recorded by a camera. From the distortions of the actual reflected image in relation to the ideal reflected image—known by calculation-deviations of the flatness in the surface areas of the surface to be measured that participate in the distorted reflection are inferred. By repeating the measurements under conditions changed in a defined manner, it is furthermore concluded how much the deviations are transverse shifting and/or pivoting of a surface area in relation to the ideal position or alignment. A very similar method as in US 5471307 A is described in EP 1429 113A1 .

According to EP 893685A2 , a surface to be measured that reflects in an ideally flatly directed manner is illuminated by multiple light sources, which are designed as much as possible as punctiform and are spaced apart at defined positions from the surface to be measured, using light propagating in a divergent (thus not collimated) manner. By means of a detector surface located at close range to the light sources, the positions of the images of the individual light sources reflected on the measured surface are determined. If the arrangement is selected so that the light beams which are reflected back onto the detector surface originating from a light source are incident almost precisely perpendicularly on the surface to be measured, the measure of the off-set of the point of incidence of the reflected beam on the detector surface in relation to the ideal point of incidence is predominantly an indication of an inclination deviation of the measured surface at the respective reflection point, and not so much a direct indication of a linear shift of the reflection point.

Proceeding from EP 893685A2 , the object underlying the invention is to design a method and a device for measuring the flatness of surfaces, such as the surface of flat glass panels, with strict observance of cost-effectiveness in an improved manner such that both inclination angle and absolute position of points of the surface to be measured are detected as directly as possible, and that the flatness measurement is less dependent on the reflection properties of the measured surface.

To achieve the object, the features are adopted from EP 893685 A2 that a device is used which is provided to illuminate the surface to be measured by multiple light sources spaced apart at defined positions from the surface to be measured using light propagating in a divergent manner, and to capture mirror images of the light sources which are based on directed reflection of the light emitted in a scattered manner by the light sources on the surface to be measured by a camera, so that from the position of the depictions of the mirror images of the light sources, the value pair of position and alignment of the associated reflection surface area on the surface to be measured can be back calculated.

As an improvement thereof according to the invention, it is proposed that multiple light sources also be provided on said device, which emit collimated light along defined straight lines onto the surface to be measured, and the camera of the device be designed to also capture the light scattered diffusely at the respective point of incidence of the collimated light beams, so that the position of the respective point of incidence on the surface to be measured can be back calculated from the image recorded by the camera.

Due to the diversity of the two measurements—once light reflected in a directed manner that originates from a light source emitting in a divergent manner, once light reflected in a scattered manner which originates from a light source emitting in a collimated manner—results are achieved, from which the actual shape of the surface to be measured can be inferred substantially better and more directly than if only one of the two measurement principles were used with an increased number of measurement points. A further advantage is that both surfaces reflecting ideally in a directed manner and surfaces reflecting ideally in a diffuse manner, and also all surfaces which reflect both in a directed and in a diffuse manner in any mixed way can be measured using the device. Thirdly, the device also provides findings about the extent to which the surface to be measured reflects in a directed and scattering manner, by which information can also be sensorially captured about the surface to be measured which goes beyond the location and alignment of partial surfaces.

These advantages are achieved under very advantageous economic conditions, since many of the essential parts of the device power supply, camera, data processing unit, data transmission unit, circuit board which carries the individual elements-can be used jointly for both measurement principles and therefore only have to be present once per device.

### THE INVENTION WILL BE EXPLAINED IN MORE DETAIL ON THE BASIS OF DRAWINGS

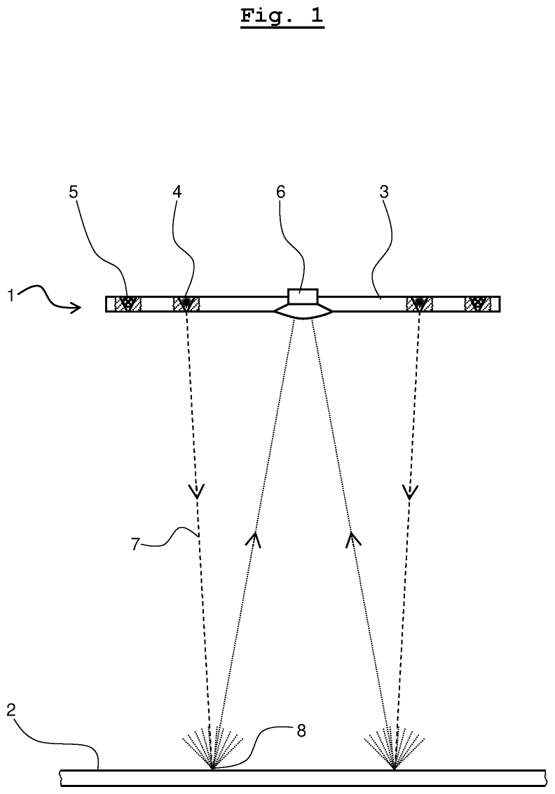

FIG. 1: shows a very stylized side view of an exemplary device according to the invention during the intended measuring use with light sources emitting in a collimated manner. Light beams are symbolized by dashed or dotted lines.

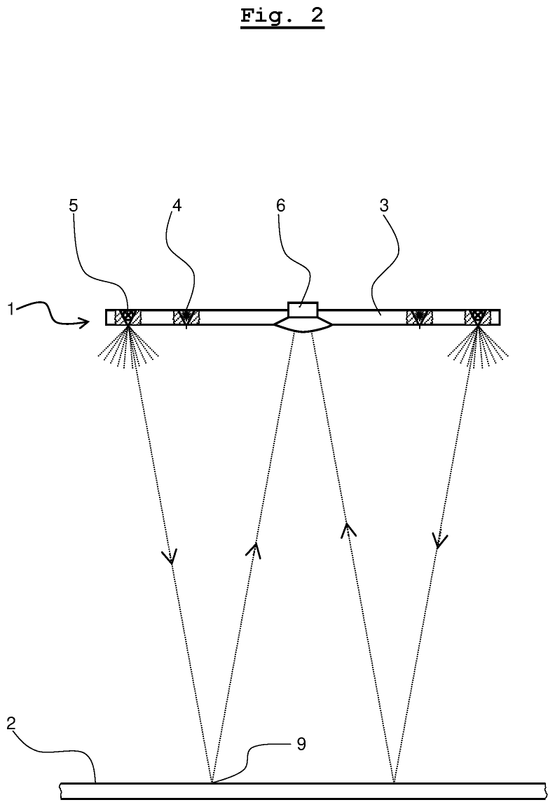

FIG. 2: shows the arrangement from FIG. 1 in the same manner as FIG. 1 during the intended measuring use with light sources emitting in a divergent manner. Light beams are symbolized by dotted lines.

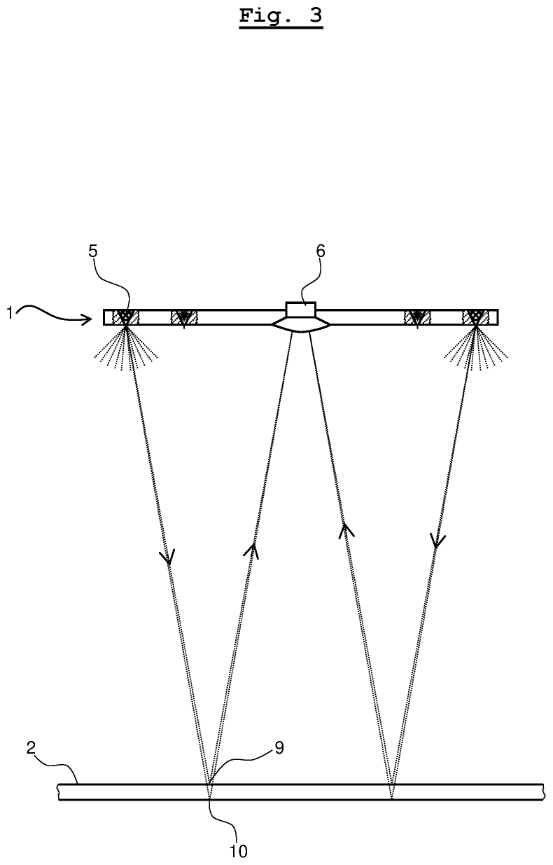

FIG. 3: shows the arrangement from FIG. 1 and FIG. 2 in the same manner as FIG. 1 during the intended measuring use with light sources emitting in a divergent manner during the use for measuring the thickness of a flat glass.

The drawings show an exemplary device 1 according to the invention and an object, which is arranged at a distance to the device 1, and the surface side of which facing toward the device 1 is the surface 2, the flatness of which is to be measured with the aid of the device 1.

The device 1 comprises a circuit board 3, at least three light sources 5, which emit light propagating in a divergent manner, at least three light sources 4, which emit light propagating in a collimated manner, as well as a camera 6, and further parts (not shown), which are required for the operation of the light sources 5, 4 and the camera 6, such as a power supply, electrical lines, and a control unit at least for switching the light sources and the camera, and controlling the transmission of the image data captured by the camera 6.

Ideally, the at least three light sources 5, which emit light propagating in a divergent manner, are arranged along the circumference of an imaginary circle at equal angular intervals in relation to one another. Likewise, the at least three light sources 4 which emit light propagating in a collimated manner, are also ideally arranged along the circumference of an imaginary circle at equal angular intervals in relation to one another. Ideally, the circle, on the circumference of which the light sources 5 are located, and the circle, on the circumference of which the light sources 4 are located, are arranged coaxially to one another, and the common axis of the two circular areas ideally extends through the center point of the detector surface of the camera 6, and the detector surface of the camera 6 is aligned normal to this axis. Ideally, the surface 2 to be measured is arranged so that if it were perfectly flat, it would be located precisely parallel to the plane of said circles, and therefore normal to said axis. Particularly clearly comprehensible relationships, and simple formulas for the mathematical conversion of the measurement results into a Cartesian coordinate system result if in addition precisely four light sources 5, 4 are also used in each case.

In the state according to FIG. 1, only the light sources 4 which emit light in a collimated manner along one precisely defined straight line 7 in each case are in operation. The light of these light sources 4 only illuminates the surface 2 at a single small partial surface 8 in each case and is generally partially absorbed there, partially reflected in a directed manner, and partially reflected in a scattered manner. The positions of the partial surfaces 8, each of which is illuminated by a light source 4 radiating in a collimated manner, are ideally selected in relation to the positions of the respective irradiating light sources 4 and the camera 6 so that the light reflected away in a directed manner from the partial surfaces 8, which originally comes from one of the light sources 4 radiating in a collimated manner, is directed past the camera 6, thus cannot be captured by the camera 6. This means that light which is emitted by one of the light sources 4 radiating in a collimated manner can only strike the camera 2 as light reflected in a scattered manner in each case on one of the partial surfaces 8 of the surface 2 to be measured. Since the straight line 7, along which the light from the light source 4 floods the surface 2, is arranged precisely defined in space, and since it is thus detectable precisely by the camera from which direction said scattered light comes to its detector surface, it can therefore be calculated unambiguously where in space the respective partial surface 8 reflecting in a scattered manner of the surface 2 to be measured is located.

If the surface 2 to be measured reflects almost exclusively in a directed manner, light which is emitted in a collimated manner by the light sources 4 can only reach the camera 6 with a comparatively very low intensity. In these cases, a high intensity of the emission of the light sources 4 is to be set and a very high light sensitivity of the camera 6 is also to be set, at least on the spectral range in which the light sources 4 radiate.

In the state according to FIG. 2, only the light sources 5 which emit light in a divergent manner are in operation. The light of these light sources 5 illuminates the surface 2 substantially uniformly over a large area and is at least partially reflected, thus mirrored, thereby in a directed manner. The camera 6 is therefore capable of recording an image of the arrangement of the light sources 5 which emit light in a divergent manner, in which image the mirror images of these light sources 5 occur as bright spots. Under the assumption that the normal distance between the plane in which the light sources 5 are located and the plane in which the surface 2 is substantially located is known, value pairs can be calculated from the positions of said bright spots in the reflected image, which each define a possible position in space and a possible angle alignment matching to this position with respect to the respective partial surface 9 reflecting an image of a light source 5.

In practice, it is to be expected that light is reflected not only in a directed, but also in a scattered manner on the surface 2, and therefore scattered light which does not come from the partial surface 9 of the surface 2 to be measured is also captured by the camera 6. The light reflected in a scattered manner arrives at the detector surface of the camera 6 with significantly lower intensity than the light reflected in a directed manner, however. The pixels induced by the light reflected in a scattered manner of the image captured by the camera 6 can easily be recognized and discarded by data processing due to their lower brightness.

Ideally, the positions of the partial surfaces 9 and the partial surfaces 8, for the case that the surface 2 to be measured is ideally flat and is ideally precisely positioned, are selected so that they coincide, thus that a partial surface 9 from which light reflected in a directed manner of one of the light sources 5 emitting in a divergent manner is reflected onto the camera 6, is precisely also a partial surface 8, from which light reflected in a scattered manner of one of the light sources 4 emitting in a collimated manner is reflected onto the camera 6. The position of the partial surface 8, which can be calculated from the measurement principle according to FIG. 1, can then be sought in the array of value pairs which are calculated from the measurement principle of FIG. 2, and the inclination indicated in the relevant value pair can be uniquely defined as the inclination of the relevant partial surface 9, 8.

Even if the two different measurements according to FIG. 1 and according to FIG. 2 claim the same partial surfaces 8, 9 on the surface 2 to be measured, they do not need to take place in chronological succession, but rather they can also take place at the same time. For this purpose, the light of the light sources 5 emitting in a divergent manner only has to be distinguishable from that of the light sources emitting in a collimated manner during or after the detection by the camera 6. This distinguishability can be achieved, for example, by different light colors or by different frequencies of intensity variations of the emission of the light sources.

If the light sources 5 emitting in a divergent manner and the light sources 4 emitting in a collimated manner claim different relevant partial surfaces 9, 8 on the surface 2 to be measured, from which reflected light is radiated at the camera 6, a dis-tinction is already possible by the location resolution of the camera 6 as to whether the light arriving from one of the partial surfaces 9, 8 at the camera 6 originally comes from one of the light sources 5 emitting in a divergent manner or one of the light sources 4 emitting in a collimated manner.

If the invention is used to monitor the flatness of flat glasses in a processing system for this purpose, a whole array of devices according to the invention are best arranged adjacent to one another, so that they jointly cover at least a width of the flat glasses typically to be monitored.

According to an advantageous refinement of the invention illustrated by FIG. 3, the device 1 according to the invention is also used to measure the thickness of flat glasses using the light sources 5 emitting in a divergent manner. If the surface 2 to be measured according to FIG. 1 and FIG. 2 is the surface of a flat glass panel facing toward the device 1, then a reflection that can be captured by the camera 6 not only occurs on the surface 2 on the partial surface 9, but also on the second glass surface located underneath on the partial surface 10. The camera image is then also interpretable so that the partial surfaces 8 and 10 or 9 and 10 do not appear as a dot or small circle in the image recorded by the camera 6, but either as a short line or as a narrow oval surface or as two dots. In this case, the length of the short line or the ratio of length to width of the oval surface or the center distance of the two dots is proportional to the glass thickness. The method functions particularly well if the light sources 5 emitting in a divergent manner are used for the glass thickness measurement and if the emission surfaces of these light sources have a very small diameter. For example, an SMD-LED having a diameter of the emission surface of approximately 0.3 mm is readily available and well suitable. Therefore, using the method outlined in FIG. 3, thicknesses of flat glasses can be precisely detected to one tenth to one one-hundredth of a millimeter. The method known per se of so-called sub-pixel interpretation (subpixel resolution) is to be applied in the evaluation of the camera image to establish the glass thickness.

It is also possible to measure the glass thickness using the light sources 4 emitting in a collimated manner, wherein one challenge in this is capturing the small proportion of light which is reflected in a scattered manner from the surface of the glass panel facing away from the camera 6.

The achievable measurement accuracy becomes better the more acute (the smaller) the angle is between the light beams participating in the measurement and the surface 2.

A particularly advantageous use case of the device according to the invention with application of the described glass thickness measurement is present if flat glass panels are to be mounted by machine in a vertical position in compartments, which are separated from one another only by parts similar to fork tines, as closely as possible, but without damage and without touching one another. This is because it is necessary to precisely know the space required for the individual panels normal to their plane, wherein this space requirement can be calculated as the sum of glass thickness and deflection of the flat glass. Both, glass thickness and deflection, can be captured by the device according to the invention as described. This application can also be man-aged well using a device which differs from the depicted device in that it does not have light sources 4 emitting in a collimated manner, but rather only light sources 5 emitting in a divergent manner for light sources.

Moreover, it is also reasonable to use the method of subpixel interpretation for measuring the exact location of the partial surfaces 8 or 9 or to exactly determine the center of the surfaces defined, for example, as the focal point or as the inner circle center point thereof.

1. A device for measuring the flatness of a surface or the thickness of a flat glass panel, wherein the device has at least three light sources, which emit light in a divergent manner, and a camera, which is provided to capture light reflected in a directed manner on the surface and originally coming from the light sources emitting in a divergent manner,
wherein
the device also has at least three light sources, which each emit light in a collimated manner along one straight line positioned in a defined manner, wherein the camera is also provided to capture the light reflected in a scattered manner on the surface and originally coming from the light sources emitting in a collimated manner.

2. The device as claimed in claim 1, wherein the light sources which emit light in a collimated manner and the light sources which emit light in a divergent manner, as well as the camera, and a single power supply unit jointly supplying these parts and a control unit controlling all light sources and the camera are arranged on a common circuit board.

3. The device as claimed in claim 1, wherein the at least three light sources which emit light propagating in a divergent manner are arranged along the circumference of an imaginary circle at equal angular intervals to one another, and that the at least three light sources which emit light propagating in a collimated manner are arranged along the circumference of an imaginary circle at equal angular intervals to one another, and that the two circles are arranged coaxially to one another, and that the common axis of the two circular surfaces extends through the center point of the detector surface of the camera.

4. The device as claimed in claim 3, wherein it has precisely four light sources which emit light propagating in a divergent manner and has precisely four light sources which emit light propagating in a collimated manner.

5. A method for measuring the flatness of a surface using a device as claimed in claim 1, wherein a partial surface on the surface, from which light reflected in a directed manner of one of the light sources emitting in a divergent manner is reflected onto the camera, is precisely also a partial surface from which light reflected in a scattered manner of one of the light sources emitting in a colli-mated manner is reflected onto the camera.

6. A method for measuring the flatness of a surface using a device as claimed in claim 1, wherein the light reflected in a directed manner away from a partial surface, which originally comes from one of the light sources emitting in a collimated manner, is directed past the camera.

7. The method as claimed in claim 5.

8. The method as claimed in claim 5, wherein it is used to measure the flatness of a flat glass surface, wherein in addition to capturing the reflections on the surface facing toward the device by way of the camera, reflections are also captured which originate from the surface of the flat glass facing away from the device, and the thickness of the flat glass is back calculated from the optical information thus captured.

9. The method as claimed in claim 5, wherein it is used to measure properties of flat glasses, and that multiple devices are arranged adjacent to one another in an array for this purpose.

10. A method for measuring the thickness of a flat glass panel, wherein a device for measuring the flatness of a surface is used for this purpose, wherein the device has at least three light sources, which emit light in a divergent manner, and a camera, which is provided to capture the light reflected in a directed manner on the surface and originally coming from the light sources emitting in a divergent manner, wherein the surface of the flat glass panel facing toward the deice is used as the surface, and wherein the surface of the flat glass panel facing away from the device is used as a second surface, which reflects light that originates from the light sources to the camera, wherein both an image of the partial surface from which light is reflected to the camera from the side of the flat glass panel facing toward the camera and an image of the partial surface from which light is reflected to the camera from the side of the flat glass panel facing away from the camera are captured by the camera, and wherein the thickness of the flat glass panel is back calculated from the distance between these two images.
